(19) United States
(12) Patent Application Publication
(10) Pub. No.: US 2017/0177198 A1
(43) Pub. Date: Jun. 22, 2017

(54) SYSTEM AND METHOD TO DISPLAY SELECTABLE ATTRIBUTE INFORMATION ASSOCIATED WITH DATA ELEMENTS

(71) Applicant: Arbor Networks, Inc., Burlington, MA (US)

(72) Inventors: Eleanor O' Neill, Burlington, MA (US); Louis Susi, Boxford, MA (US); Jeffrey Doppke, Canton, MI (US)

(73) Assignee: Arbor Networks, Inc., Burlington, MA (US)

(21) Appl. No.: 14/974,738

(22) Filed: Dec. 18, 2015

(51) Int. Cl. G06F 3/0484; G06F 3/14; G06F 3/0482

(52) U.S. Cl. CPC G06F 3/04845; G06F 3/0482; G06F 3/14; G06F 3/04842

(57) ABSTRACT

A method and computer system are provided. A processing device of the computer system is configured to execute a browser function. The browser function is configured to access an information resource having a data element that is associated with an attribute that includes information. The browser function is further configured to display the information resource in a display portion of a display screen of the processing device. The data element is associated with an area positioned at a location of the displayed information resource, wherein the area is designated for displaying the data element. The browser function is further configured to display the attribute's information in the area associated with the data element in response to a first user action.

### FIELD OF THE INVENTION

The present technology relates to displaying data related to an information resource when display real estate is limited and, more particularly, displaying a full version of a truncated or hidden data element at the location of the data element.

### BACKGROUND OF THE INVENTION

Webpages and other HTML documents that are displayed in a browser application can include data elements that are truncated or hidden, such as due to space constraints. When a user hovers a position indicator over the data element's location, the browser can display the related information in a temporary bubble which is hidden when the position indicator is moved away from the data element. However, the bubble overlays other data elements of the information resource, blocking other data elements so that the other data elements cannot be viewed. Additionally, the browser does not provide the capability to select or copy the related data while it is displayed, such as to use the related data in another software application. In order to be able to select the related data, a browser plugin is needed, or the browser would need to have gained permission from the operating system of the computing device being used. However, plugins and permission requirements add features and complications that may not be desired.

### SUMMARY OF THE INVENTION

The purpose and advantages of the illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with a purpose of the illustrated embodiments, in one aspect, a method and computer system having a processing device is provided. The processing device is configured to execute a browser function. The browser function is configured to access an information resource having a data element that is associated with an attribute that includes information. The browser function is further configured to display the information resource in a display portion of a display screen of the processing device. The data element is associated with an area positioned at a location of the displayed information resource, wherein the area is designated for displaying the data element. The browser function is further configured to display the attribute's information in the area associated with the data element in response to a first user action.

In accordance with another aspect of the disclosure, a computing system is provided that includes a communication interface that interfaces with a network for communicating with a client device, the client device having a client processing device, and at least one processing device. The processing device is configured to provide an information resource to the computing device via the communication interface, wherein the information resource includes a data element having an attribute, wherein the attribute includes information. An event handler is bound to the data element. The information resource is configured so that when the information resource is accessed by the client computing device, the information resource is displayed in a display portion of a display screen of the client computing device with the data element. The data element is associated with an area positioned at a location of the displayed information resource, the area being designated for displaying the data element. The attribute's information is displayed in the area associated with the data element in response to a first user action.

### BRIEF DESCRIPTION OF THE DRAWINGS

The accompanying appendices and/or drawings illustrate various, non-limiting, examples, inventive aspects in accordance with the present disclosure:

FIG. 1 illustrates an example communication network;

FIG. 2 illustrates an example network device/node;

FIG. 3 illustrates a block diagram of a communication network including a web server that provides information resources configured in accordance with the present disclosure;

FIG. 4 illustrates a schematic diagram of components of the information resource;

FIG. 5 illustrates screen shots showing a displayed information resource as the display changes in response to user actions; and

FIG. 6 illustrates a flowchart of a method in accordance with the present disclosure.

### DETAILED DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be executed by a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

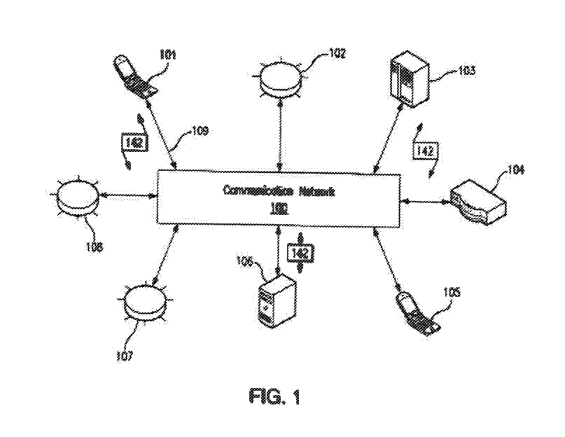

Turning now descriptively to the drawings, in which similar reference characters denote similar elements throughout the several views, FIG. 1 depicts an exemplary communications network 100 in which below illustrated embodiments may be implemented.

It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

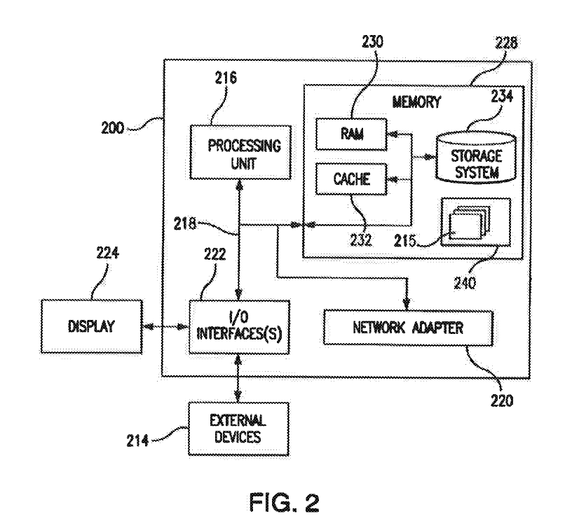

FIG. 2 is a schematic block diagram of an example network computing device 200 (e.g., client computing device 103, server 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various embodiments of the present disclosure. Device 200 is only one example of a suitable system and is not intended to suggest any limitation as to the scope of use or functionality of embodiments of the disclosure described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like.

Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

Device 200 is shown in FIG. 2 in the form of a general-purpose computing device. The components of device 200 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the disclosure.

Program/utility 240, having a set (at least one) of program modules 215, may be stored in memory 228 by way of example, and not limitation, which can include an operating system, one or more application programs, other program modules, as well as program data. Each of the operating system, one or more application programs, other program modules, and program data or some combination thereof, may be adapted for implementation in a networking environment. Program modules 215 generally carry out the functions and/or methodologies of embodiments of the disclosure as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

In the description that follows, certain embodiments may be described with reference to acts and symbolic representations of operations that are performed by one or more computing devices, such as the computing system environment 200 of FIG. 2. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

FIGS. 1 and 2 are intended to provide a brief, general description of an illustrative and/or suitable exemplary environment in which embodiments of the below described present disclosure may be implemented. FIGS. 1 and 2 are exemplary of a suitable environment and are not intended to suggest any limitation as to the structure, scope of use, or functionality of an embodiment of the present disclosure. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

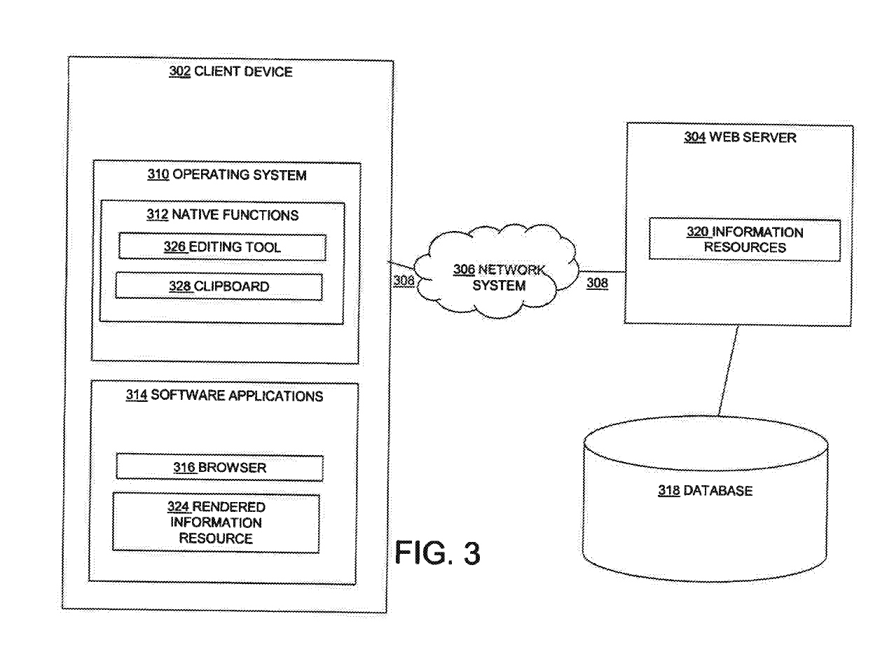

With the exemplary communication network 100 (FIG. 1) and computing device 200 (FIG. 2) being generally shown and discussed above, description of certain illustrated embodiments of the present disclosure will now be provided. With reference now to FIGS. 3-6, a communication network 300 (similar to communication network 100) is generally shown in which a client device 302 communicates with a web server 304 via a network system 306, such as the Internet or one or more LANs or WANs, and one or more communication links 308. The communication links 308 can each include a single or multiple wired and/or wireless links. The client device 302 and the web server 304 can be respective computer systems that each function as nodes (e.g., nodes 101-105, 107, or 108) of the network system 306.

Communication network 300 is configured so that data related to data elements included in an information resource (e.g., a webpage written in a markup language, such as HTML) can be displayed in response to a user action. Additionally, the displayed related data can be selectable, such as to copy and paste the displayed related data, without using a browser plugin and without requiring permission from the operating system. The related data can be an expansion of a data element's abbreviated form or can augment information related to the data element.

The client device 302 and the web server 304 can each be configured similarly to the network computing device 200 shown in FIG. 2, such as to include a processing unit 216, a network adapter 220, an I/O interface 222, and memory 228. Client device 302 can be, for example, a mobile or fixed device in which program modules 215 include an operating system 310 that provides native functions 312. Program modules 215 of client device 302 can further include software applications 314, including a browser application 316 (also referred to as a “browser”). The operating system 310 manages the hardware and the software resources of the client device 302. The native functions 312 provided by the operating system 310 and separate from software applications 314, can provide common services to the software applications 314.

The operating system 310 can schedule tasks for efficient use of the hardware and software resources of the client device 302. The operating system 310 can also manage the hardware functions and act as an intermediary between one of the software applications 314 and the hardware of the client device 302. The operating system 310 can further provide one or more functions that are called by or interrupted by the software applications 314 (e.g., via a system call). Examples of popular modern operating systems include Android, BlackBerry, BSD, Chrome OS, iOS, Linux, OS X, QNX, Microsoft Windows, Steam OS,[3] Windows Phone, and z/OS, FreeRTOS, Micrium, and VxWorks.

The web server 304, which can be included in the World Wide Web (WWW), can store or access, e.g., from a database 318, one or more information resources 320 that can be browsed and accessed by the browser 316 of the client device 302. The information resources 320 are can be identified by a Uniform Resource Identifier (URI/URL) The information resources 320 can include, for example, markup files, such as HTML or XML files or the equivalent, which can include a webpage, a video file, an audio file, an image file, a graphic file, and/or a text file. Once the information resource 320 has been retrieved, the browser 316 renders the information resource 320 by displaying the rendered information resource 324 as an interactive document, e.g., using HTML, XML, and/or associated content.

In an embodiment, an information resource 320 can be stored in the client device's 302 local storage 322 or by a device in a local network of the client device 302. The browser 316 can access the information resource 320 from the local storage 322 or local network, render the information resource, and display the rendered information resource 324 on a display device of the client device 302, e.g., wherein the rendered information resource 320 is stored temporarily in random access memory (RAM) of the client device 302.

The browser 316 can include a user interface, layout engine, rendering engine, JavaScript interpreter, UI backend, networking component, and data persistence component. These components each achieve different functionalities of the browser 316 to together provide the capabilities of a web browser. The browser 316 can retrieve (fetch), present, and/or traverse information resources 320 provided by one or more web servers 304. The browser 316 can navigate the WWW by following links provided in the information resources 320. Examples of browsers that are currently available include Firefox, Internet Explorer, Google Chrome, Opera, and Safari.

The native functions 312 provided by the operation system 310 can include an editing tool 326 and a clipboard 328. The editing tool 326 provides the ability to edit data associated with a software application 314, including the ability to select, copy, and/or paste text. The clipboard 328 includes a section of memory assigned by the operating system 310 to provide temporary storage for data associated with the software applications 314. Using the editing tool 326, data can be copied from content displayed by a software application 314 and pasted into the clipboard 326. The data stored in the clipboard 326 can be accessed by another software application 314, such as to paste a copy of data stored in the clipboard 326 into a file being processed by the other software application 314.

The native function 312, including editing tool 326 and the clipboard 328, are available to the user, even without using a plug-in, and without a source of the information resource 320 obtaining permission from the operating system 310 to access the native functions 312.

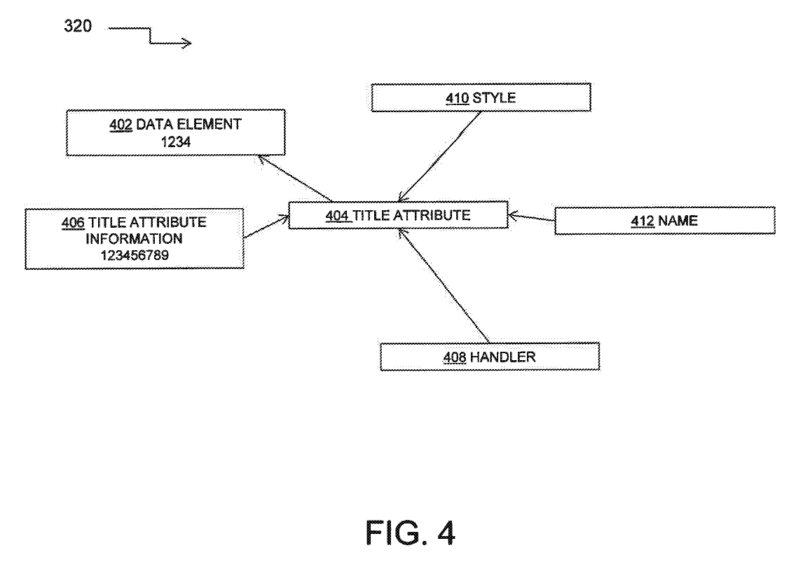

With reference to FIG. 4, a data element 402 included in an information resource 316 is shown. The data element 402 can be, for example, an HTML div element. The data element 402 is associated with an attribute 404, such as an HTML data attribute. The attribute 404 is associated with attribute information 406, such as data attribute information associated with the data element 402. In client devices 302 that have a hover capability, attribute information 406 can be displayed when a user hovers a position indicator, such as a cursor, over the data element 402 while being displayed in the rendered information resource 316. Hovering the position indicator refers to placing the position indicator over the data element 402 or the region of the data element 402 to point to the data element 402 without selecting the data element 402. The attribute information 406 that is displayed while a user hovers the position indicator over the data element 402 is displayed in an area that is near the area in which the data element 402 is displayed. The data element 402 continues to be displayed and visible. The attribute information 406 disappears from view when the user is no longer hovering the position indicator over the data element 402. When the attribute information is displayed, the attribute information cannot be selected or copied. Some client devices 302, such those with touch screen displays, do not have hovering capabilities.

In addition, a handler, e.g., a handler 408, such as an event handler, e.g., a handler 408, is bound to the data element 402. The handler 408 defines responses to inputs received from users, such as operation of a clickable user pointing device, (e.g., a mouse), a keyboard, a touch screen, or voice commands. Clicking a mouse refers to pointing to the data element 402 with the position indicator and performing a user action (such as clicking a button once or twice) to select the data element 402. Client devices 302 that have touch screens provide for selecting a data element 402 by tapping or touching with a prolonged touch the displayed data element, rather than clicking. The use of the term “clicking” as used below is intended to refer to user actions for selecting the displayed data element 402, for example and without limitation, using a clicking action associated with a pointing device, operating a keyboard, touching or tapping a touch screen, and inputting voice commands.

Without limitation, the event handler can respond to a variety of user actions (e.g., manipulation of a pointing device, actuation of keys on a keyboard, tapping or touching a touch screen, etc.). The responses can include, for example, causing or discontinuing display of the attribute information 406, determining a style in which the attribute information 406 is displayed, and determining whether the attribute information 406 can be accessed by the native functions 312, such as the editing tool 326 and the clipboard 328.

The handler 408 can be, for example, a Javascript click handler created e.g., using Javascript DOM. The handler 408 includes programmable instructions that are executed by the processing device of the client device 302 that interface with the native functions 312 of the client device 302. In particular, the handler 408 responds to user actions, such as hovering the position indicator, clicking or right clicking a pointing device, operating a keyboard, and/or tapping or touching a touch screen, and interfaces with the display, the editing tool 326, and the clipboard 328. The handler 408 can respond to the user actions by displaying and/or altering the display style of the attribute information 406 or the data element 402, and giving the user access to use the editing tool 326 to select and copy the displayed attribute information 406 or a portion thereof. Additionally, the user's access to the editing tool 326 can be used to paste the copied attribute information 406 into the clipboard 328.

When the information resource is displayed on a display screen of the client device 302, the data element is associated with an area that is positioned at a location of the displayed information resource. This area is designated for displaying the data element. The data element may be hidden or displayed. When displayed, the data element 402 may include a truncated version of data, wherein the attribute information 406 includes the full version. When the attribute information is displayed, it is displayed in the area associated with the data element 402. The displayed attribute information 406 can be displayed instead of the data element 402 or can overlay the data element 402 so that only the attribute information 406 is viewable in the location that the data element 402 was previously viewable.

Additionally, a style 410 can be applied to the attribute information 406, such as by using CSS styling. The style 410 can be selected in order that when the attribute information 406 is displayed, the attribute information 406 is positioned in association with the data element 402 in a selected layout. For example, the attribute information 406 can be displayed using a layout in which information displayed in the rendered information resource 324 is minimally obscured. For example, a CSS position property, such as “relative” or “absolute” can be assigned to the attribute information 406. In addition, the style 410 can provide indicators to the data element 402 and the attribute information 406 to visually or audibly indicate that the data element 402 is associated with additional information that can be revealed, and that the displayed attribute information 406 is temporarily revealed and can be selected, copied, and/or pasted.

The attribute 404 can be further associated with a name 412. When two or more HTML data elements 402 have attributes 404, such as HTML data attributes, that share the same name, attribute information 406 for each of these data elements 402 can be displayed at the same time by clicking in the region of the data elements 402 and can all be selectable. In this way, a user can compare, copy, and/or paste the attribute information 406 for these data elements 402 using the native functions 312. In other words, once a first data element 402 has been clicked upon and its attribute information 406 is displayed, attribute information 406 for another (or multiple) data elements 402 having the same name 412 associated with their attributes 404 can be displayed by clicking on these other data elements 402. Since the other data elements 402 have the same name 412 as the first data element 402, the attribute information 406 associated with the first data element continues to be displayed and is not discontinued. When the user clicks the position indicator in a region that is not associated with the data element 402 or the other data elements 402 that have the same name 412, the display of the attribute information 406 for the first data element 402 and the other data elements 402 is discontinued.

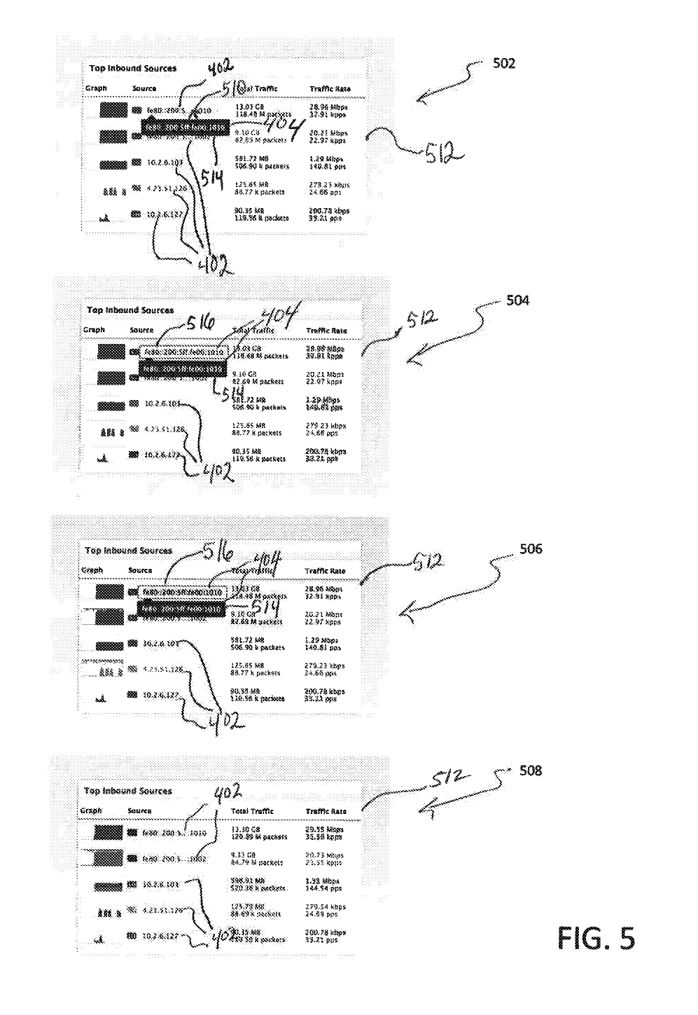

FIGS. 5A-5D show screenshots 502, 504, 506, and 508 in which implementation of the disclosure is illustrated. The screenshot 502 shown in FIG. 5A shows a data element 402 while a user is hovering a position indicator 510 over the data element 402, such as by manipulating a user input device, e.g., a mouse. The data element 402 in this example is a truncated IPv6 address that is included in a table 512 showing network status associated with a multitude of data elements 402. Due to the length of the IPv6 address and limited display screen space, the IPv6 address displayed for data element 402 is truncated so that only a portion of the digits of the IPv6 address is shown.

When the user hovers the position indicator 510 over the data element 402, the visualization of the position indicator 510 as displayed changes (e.g., to a graphical design of a hand pointing a finger) to indicate that the screen region that includes and/or surrounds the data element 402 being hovered over is selectable. As indicated by the position indicator's 510 shape, the data element 402 can be selected using the user input device (e.g., by clicking the mouse or touch screen in that region). Attribute information 406, including the complete IPv6 address, is displayed in an unselectable pop-up window 514. The attribute information 406 displayed in the pop-up window 514 when the position indicator 510 merely hovers over the data element 402 cannot be selected or used by the native functions 312. The user action described for viewing attribute information without selecting the data element 402 is described as hovering the position indicator 510 over the data element 402, however the disclosure is not limited to hovering the position indicator 510, and other user actions are envisioned.

The screenshot 504 shown in FIG. 5B shows a selectable display element 516 that is displayed when the user selects the data element 402, such as by clicking the mouse in the region 15 that immediately includes and/or surrounds the data element 402. Immediately surrounding the data element 402 refers to an area that is proximate the data element 402 and is associated with selection in particular of the data element 402, and not with selection of another data element 402. The user action described for selecting the data element 402 is described as clicking the position indicator in the region of the data element 402, however the disclosure is not limited to clicking in the region of the data element 402, and other user actions are envisioned.

When the data element 402 is selected, e.g., by clicking in its region, attribute information 406 is displayed in the selectable display element 516. The selectable box 516 is positioned in the area of the displayed table 512 that was reserved for designated for displaying the data element 402. The data element 402 is not visible. Instead, the data displayed inside the selectable box is visible.

Data displayed inside the selectable display element 516 can be selected using the editing tool 326 of the native functions 312. The selected data can be copied to the clipboard 328 of the native functions 312. In an embodiment, only certain functions of the editing tool 326 are enabled, such as select and copy, whereas other functions of the editing tool 326, such as edit or paste, are disabled. In another embodiment, all of the functions of the editing tool 326 are enabled, however, changes to the displayed data do not change the attribute information 406 stored with the HTML information. The selectable display element 516 continues to be displayed until the user manipulates the position indicator 510 to point and select (e.g., click) in a displayed region that is outside of the selectable display element 516.

In an embodiment, the selectable display element 516 associated with a first data element 402 continues to be displayed until the user performs a user action to discontinue the display of the selectable display element 516. A user action to cause the discontinuation can be to click the position indicator in a displayed region that is outside the displayable display element 516 associated with the first data element 402 or outside a selectable display element 516 associated with, or a region immediately including and/or surrounding, another data element 402 that has a same name 412 for the attribute 404 as the first data element 402. The user action described for discontinuing display of the selectable display element 516 is described as clicking in a different region of the data element 402, however the disclosure is not limited to clicking, and other user actions are envisioned.

The screenshot 506 shown in FIG. 5C shows a graphical indication that the data displayed in the selectable display element 516 is selected, wherein the data displayed is the attribute information 406. The attribute information 406 can be selected and copied using the editing tool 326. The copied data can be pasted into the clipboard 328.

The screenshot 508 shown in FIG. 5D shows the data elements 402, wherein none of the attribute information 406 associated with the data elements 402 is displayed after the user clicked on a displayed region of the screen that was outside of the selectable display element 516 or a region immediately including and/or surrounding another data element 402 or outside a selectable display element 516 associated with the other data element 402, wherein the other data element 402 has the same name for its attribute 404 as the first data element 402. Even once a selectable display element 516 is no longer displayed, data that was copied from a previously displayed selectable display element 516 can still be pasted into the clipboard 328 using the native functions 312.

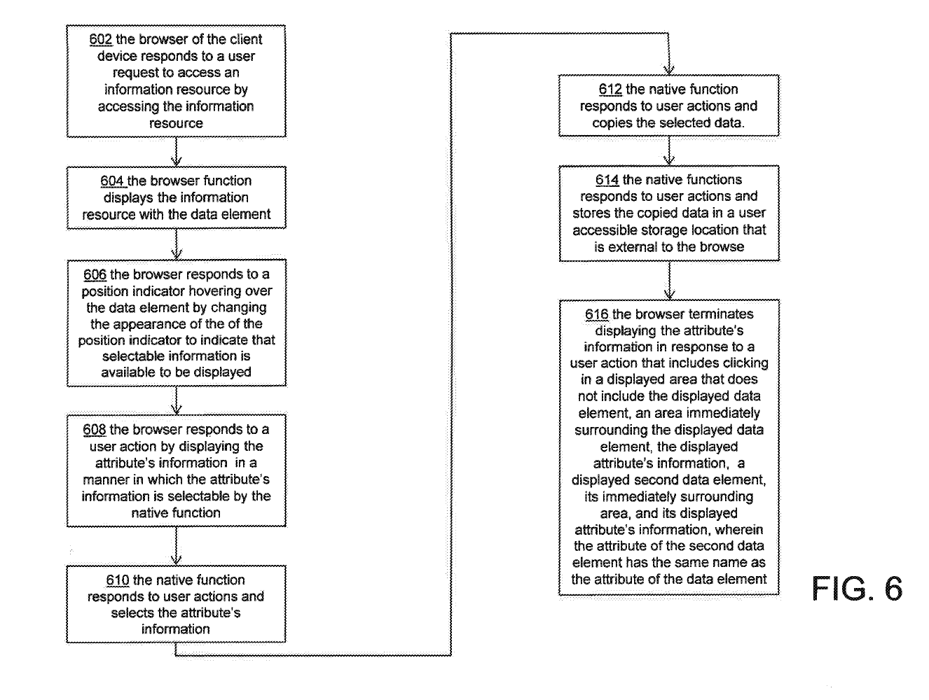

With reference now to FIG. 6, shown is a flowchart demonstrating implementation of the various exemplary embodiments. It is noted that the order of operations shown in FIG. 6 is not required, so in principle, the various operations may be performed out of the illustrated order. Also certain operations may be skipped, different operations may be added or substituted, or selected operations or groups of operations may be performed in a separate application following the embodiments described herein.

At operation 602, the browser 316 of the client device 302 responds to a user request to access an information resource by accessing the information resource. The user request can include actions such as actuation of a hypertext link or entry of a URL or IRL associated with the information resource in an address bar provided by the browser 316 for requesting information resources. The information resource can have a data element 402 that is associated with an attribute 404, wherein the attribute 404 includes information. At operation 604, the browser function displays the information resource with the data element 402. The attribute 404 can be an HTML data attribute.

At operation 606, the browser 316 responds to a position indicator 510 hovering over the data element 402 by changing the appearance of the of the position indicator 510 to visually (or audibly) indicate that selectable information is available to be displayed. In addition, at operation 606, browser 316 may display the attribute information 406 in a pop-up window 514 when the position indicator 510 hovers over the data element 402. The pop-up window 514 cannot be selected or used by the native functions 312, and is dismissed (e.g., not displayed) when the position indicator 510 does not hover over the data element 402.

The native functions 312 are external to the browser 516 and have access to the attribute's information 406 regardless of whether permission is granted. The native functions 312 can be provided separately from the browser 526, e.g., by an operating system 310 of the processing device.

At operation 608, the browser 316 responds to a user action by displaying the attribute's information 406 in a manner in which the attribute's information 406 is selectable by the native function 312, such as by the editing tool 326. The user action can include, for example, clicking in a region immediately surrounding or including the displayed data element 402. The attribute's information 406 can be displayed in a position that is relative to a position of the displayed data element 402, so as to minimize obscuring other information that is displayed.

At operation 610, the native function 312 (e.g., editing tool 326) responds to user actions and selects the attribute's information 406. The user actions can be actions such as “click and drag” or operation of particular combinations of keys designated for selecting data, but is not limited thereto. At operation 612, the native function 312 responds to user actions and copies the selected data. The user actions can be actions, such “right-clicking” on the selected data and selecting a copy function from a drop-down menu, or using a particular combination of keys designated for copying data, but is not limited thereto.

At operation 614, the native functions 312 (e.g., clipboard 328) responds to user actions and stores the copied data in a user accessible storage location that is external to the browser 316. The user accessible storage location can be provided by the operating system 310 of the client device 302.

At operation 616, the browser 316 can discontinue displaying the attribute's information 406 in response to a user action, such as clicking in a displayed area that does not include the displayed data element 402, an area immediately surrounding the displayed data element 402, and the displayed attribute's information 406.

In accordance with an embodiment, at operation 616, the display of the attribute's information 406 is not discontinued when a user action includes clicking on a second data element 402 (or the area immediately surrounding the displayed second data element 402 or its displayed attribute's information 406), wherein the attribute 404 of the second data element 402 has the same name 412 as the attribute 404 of the data element 402. Rather, information included with the second attribute 404 can be displayed at the same time that the attribute's information 406 is displayed due to the commonality of the names 412 for the title. When two or more data elements 402 have attributes 404, selectable attribute information 406 for each of these data elements 402 can be displayed at the same time. In this fashion, the attribute information 406 can be compared, selected, copied, and/or pasted using the native functions 312.

The block diagrams in the Figures illustrate the architecture, functionality, and operation of possible implementations of systems, methods and computer program products according to various embodiments of the present disclosure. In this regard, operations described may be implemented by modules, segments, or portions of code, which comprise one or more executable instructions for implementing the specified logical function(s). It should also be noted that, in some alternative implementations, the functions described in various orders and/or substantially concurrently. It will also be noted that functions described can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system having a processing device configured to:
execute a browser function, wherein the browser function is configured to:
access an information resource having a data element, the data element having an associated attribute, the attribute including information;
display the information resource in a display portion of a display screen of the processing device, the data element being associated with an area positioned at a location of the displayed information resource, the area being designated for displaying the data element; and
display the attribute's information in the area associated with the data element in response to a first user action. The computer system of claim 1, wherein the displayed attribute's information is viewable instead of the data element.

2. The computer system of claim 1, wherein the attribute's information that is displayed is selectable by a native function executing on the processing device, selection of the attribute's information being in response to at least one second user action, wherein the native function is external to the browser and has access to the displayed attribute's information regardless of whether permission is granted.

3. The computer system of claim 3, wherein at least a portion of the selected information of the attribute is copied by the native function in response to the at least one second user action.

4. The computer system of claim 4, wherein the copied information is stored in a user accessible storage location that is external to the browser in response to the at least one second user action.

5. The computer system of claim 5, wherein the user accessible storage location is provided by an operating system of the processing device.

6. The computer system of claim 1, wherein the browser displays a visual indicator that indicates the attribute's information can be displayed and selected.

7. The computer system of claim 1, wherein the first user action includes clicking in a region immediately surrounding or including the displayed data element.

8. The computer system of claim 3, wherein the browser is further configured to discontinue displaying the selectable information in response to a third user action.

9. The computer system of claim 9, wherein the third user action includes clicking in a displayed area that does not include the displayed data element, an area immediately surrounding the displayed data element, and the displayed attribute's information.

10. The computer system of claim 3, wherein the native function is provided separately from the web browser by an operating system of the processing device.

11. The computer system of claim 3, wherein in response to performance of the at least one second user action on a second data element that has a second attribute having a name that is the same as a name of the attribute of the data element, information included with the second attribute is displayed at the same time that the attribute's information is displayed.

12. The computer system of claim 9, wherein the third user action includes clicking in a displayed area that does not include the displayed data element, an area immediately surrounding the displayed data element, the displayed attribute's information, a second data element that has a second attribute having a name that is the same as a name of the attribute of the data element, an area immediately surrounding the displayed data element, and the displayed second attribute's information.

13. A method comprising:
executing a browser function to:
access an information resource having a data element, the data element having an associated attribute, the attribute including information;
display the information resource with the data element in a display portion of a display screen of the processing device, the data element being associated with an area positioned at a location of the displayed information resource, the area being designated for displaying the data element; and
display the attribute's information in the area associated with the data element in response to a first user action.

14. The method of claim 14, wherein the displayed attribute's information is viewable instead of the data element.

15. The method of claim 14, wherein the attribute's information that is displayed is selectable by a native function executing on the processing device, selection of the attribute's information being in response to at least one second user action, wherein the native function is external to the browser and has access to the displayed attribute's information regardless of whether permission is granted.

16. The method of claim 16, further comprising:
copying at least a portion of the selected attribute's information by the native function in response to the at least one second user action.

17. The method of claim 17, further comprising storing the copied information in a user accessible storage location that is external to the browser in response to the at least one second user action.

18. The method of claim 18, wherein user accessible storage location is provided by an operating system of the processing device.

19. The method of claim 14, further comprising displaying a visual indicator that indicates the attribute's information can be displayed and selected.

20. The method of claim 16, wherein the browser is further executed to discontinue displaying the selectable information in response to a third user action.

21. The method of claim 16, wherein the native function is provided separately from the web browser by an operating system of the processing device.

22. The method of claim 16, further comprising displaying, in response to performance of the at least one second user action on a second data element that has a second attribute having a name that is the same as a name of the attribute of the data element, information included with the second attribute at the same time that the attribute's information is displayed.

23. A computing system comprising:
a communication interface that interfaces with a network for communicating with a client device, the client device having a client processing device; and
at least one processing device configured to:
provide an information resource to the computing device via the communication interface, the information resource including:
a data element having an attribute, the attribute including information; and
wherein when the information resource is configured so that when the information resource is accessed by the client computing device, the information resource is displayed in a display portion of a display screen of the client computing device with the data element, the data element being associated with an area positioned at a location of the displayed information resource, the area being designated for displaying the data element, and the attribute's information is displayed in the area associated with the data element in response to a first user action.

24. The computing system of claim 24, wherein the displayed attribute's information is viewable instead of the data element.

25. The computing system of claim 24, wherein a handler is bound to the data element, and the handler responds to at least one second user action so that the attribute's information is selectable by a native function provided by an operating system of the client computing device.

26. The computing system of claim 26, wherein the attribute's information is selected by the native function regardless of whether permission is granted by an operating system of the client computing device.

27. The computer system of claim 26, wherein the information resource is configured so that at least a portion of the selected information of the attribute is copied by the native function in response to the at least one second user action.

28. The computer system of claim 26, wherein the copied information is stored in a user accessible storage location that is provided by the operating system of the computing device in response to the at least one second user action.

29. The computer system of claim 24, wherein the first user action includes clicking in a region immediately surrounding or including the displayed data element.

30. The computer system of claim 26, wherein the information resource is further configured so that display of the selectable attribute's information is discontinued in response to a third user action.

31. The computer system of claim 31, wherein the third user action includes clicking in a displayed area that does not include the displayed data element, an area immediately surrounding the displayed data element, and the displayed attribute's information.

32. The computer system of claim 26, wherein the information resource includes a second data element having a second attribute having a name that is the same as a name of the attribute of the data element, and the information resource is configured so that in response to performance of the at least one second user action on the second data element, the second attribute's information is displayed at the same time that the attribute's information is displayed.

33. The computer system of claim 31, wherein the third user action includes clicking in a displayed area that does not include the displayed data element, an area immediately surrounding the displayed data element, the displayed attribute's information, a second data element that has a second attribute having a name that is the same as a name of the attribute of the data element, an area immediately surrounding the displayed data element, and the displayed second attribute's information.
